(19) United States
(12) Patent Application Publication
(10) Pub. No.: US 2021/0278877 A1
(43) Pub. Date: Sep. 9, 2021

(54) FRONT LIGHT MODULE AND DISPLAY DEVICE HAVING THE SAME

(71) Applicant: E Ink Holdings Inc., Hsinchu (TW)

(72) Inventors: Yun-Nan HSIEH, HSINCHU (TW); Chih-Cheng KO, HSINCHU (TW)

(21) Appl. No.: 17/114,517

(22) Filed: Dec. 8, 2020

(30) Foreign Application Priority Data
Mar. 6, 2020 (TW) 109107525

(51) Int. Cl. G06F 1/16; F21V 8/00

(52) U.S. Cl. CPC G06F 1/1609; G06F 3/0412; G02B 6/0076

(57) ABSTRACT

A front light module includes a light guide plate, a light source, and a cover. The light guide plate has a light incident surface. The light source faces the light incident surface. The cover is located on the light guide plate. The cover includes a first light guide layer, a second light guide layer, a first printing layer, and a second printing layer. The first light guide layer is located between the second light guide layer and the light guide plate. The first printing layer is located on a surface of the first light guide layer facing the light guide plate. The second printing layer is located between the first light guide layer and the second light guide layer.

### CROSS-REFERENCE TO RELATED APPLICATION

This application claims priority to Taiwan Application Serial Number 109107525, filed Mar. 6, 2020, which is herein incorporated by reference in its entirety.

### BACKGROUND

### Field of Invention

The present invention relates to a front light module and a display device having the front light module.

### Description of Related Art

A light guide plate and a cover of a display device is adhered by an optical adhesive layer, such that the light may be transmitted from the light guide plate to the cover by going through layers of mediums. However, since the refractive index of the cover is greater than the refractive index of the optical adhesive layer, the light may be partially leaked from the edge of the cover when the light is transmitted in the cover. As a result, light leaking problem of the cover may happen.

### SUMMARY

One aspect of the present disclosure is a front light module.

In some embodiments, the front light module includes alight guide plate, a light source, and a cover. The light guide plate has a light incident surface. The light source faces the light incident surface. The cover is located on the light guide plate. The cover includes a first light guide layer, a second light guide layer, a first printing layer, and a second printing layer. The first light guide layer is located between the second light guide layer and the light guide plate. The first printing layer is located on a surface of the first light guide layer facing the light guide plate. The second printing layer is located between the first light guide layer and the second light guide layer.

In some embodiments, the first printing layer is in contact with the surface of the first light guide layer facing the light guide plate.

In some embodiments, a number of the first printing layer is plural, and one of the first printing layer closest to the first light guide layer is a light absorbing layer.

In some embodiments, the second printing layer is located on a surface of the first light guide layer facing the second light guide layer.

In some embodiments, the second light guide layer is a coating layer, and the coating layer is in contact with the first light guide layer and the second printing layer.

In some embodiments, the second light guide layer has a thickness in a range of 8 micrometers to 12 micrometers.

In some embodiments, a number of the second printing layer is plural, and one of the second printing layer closest to the first light guide layer is a light absorbing layer.

In some embodiments, the second printing layer is located on a surface of the second light guide layer facing the first light guide layer.

In some embodiments, the entire surface of the second light guide layer is planar, the second printing layer is in contact with the surface of the second light guide layer facing the first light guide layer, and the second printing layer is spaced apart from the first light guide layer.

In some embodiments, the second light guide layer has a thickness in a range of 70 micrometers to 80 micrometers.

Another aspect of the present disclosure is a display device.

In some embodiments, the display device includes a front light module and a display module. The front light module includes alight guide plate, a light source, and a cover. The light guide plate has a light incident surface. The light source faces the light incident surface. The cover is located on the light guide plate. The cover includes a first light guide layer, a second light guide layer, a first printing layer, and a second printing layer. The first light guide layer is located between the second light guide layer and the light guide plate. The first printing layer is located on a surface of the first light guide layer facing the light guide plate. The second printing layer is located between the first light guide layer and the second light guide layer. The light guide plate is located between the display module and the cover.

In some embodiments, the first printing layer is in contact with the surface of the first light guide layer facing the light guide plate.

In some embodiments, a number of the first printing layer is plural, and one of the first printing layer closest to the first light guide layer is a light absorbing layer.

In some embodiments, the second printing layer is located on a surface of the first light guide layer facing the second light guide layer.

In some embodiments, the second light guide layer is a coating layer, and the coating layer is in contact with the first light guide layer and the second printing layer.

In some embodiments, the second light guide layer has a thickness located in a range from about 8 micrometers to 12 micrometers.

In some embodiments, a number of the second printing layer is plural, and one of the second printing layer closest to the first light guide layer is a light absorbing layer.

In some embodiments, the second printing layer is located on a surface of the second light guide layer facing the first light guide layer.

In some embodiments, the entire surface of the second light guide layer is planar, the second printing layer is in contact with the surface of the second light guide layer facing the first light guide layer, and the second printing layer is spaced apart from the first light guide layer.

In some embodiments, the second light guide layer has a thickness located in a range from about 70 micrometers to 80 micrometers.

In the aforementioned embodiments, the light transmitted in the first light guide layer may be absorbed by disposing the first printing layer on the surface of the first light guide layer facing the light guide plate and disposing the second printing layer on the surface of the first light guide layer facing the second light guide layer. As such, the light is prevented from leaking through the edge of the cover.

### BRIEF DESCRIPTION OF THE DRAWINGS

The invention can be more fully understood by reading the following detailed description of the embodiment, with reference made to the accompanying drawings as follows:

FIG. 1 is a cross-sectional view of a display device according to one embodiment of the present disclosure;

FIG. 2 is a partially enlarge view of the display device in FIG. 1;

FIG. 3 is a cross-sectional view of a display device according to another embodiment of the present disclosure;

FIG. 4 is a cross-sectional view of a display device according to another embodiment of the present disclosure; and

FIG. 5 is a cross-sectional view of a display device according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

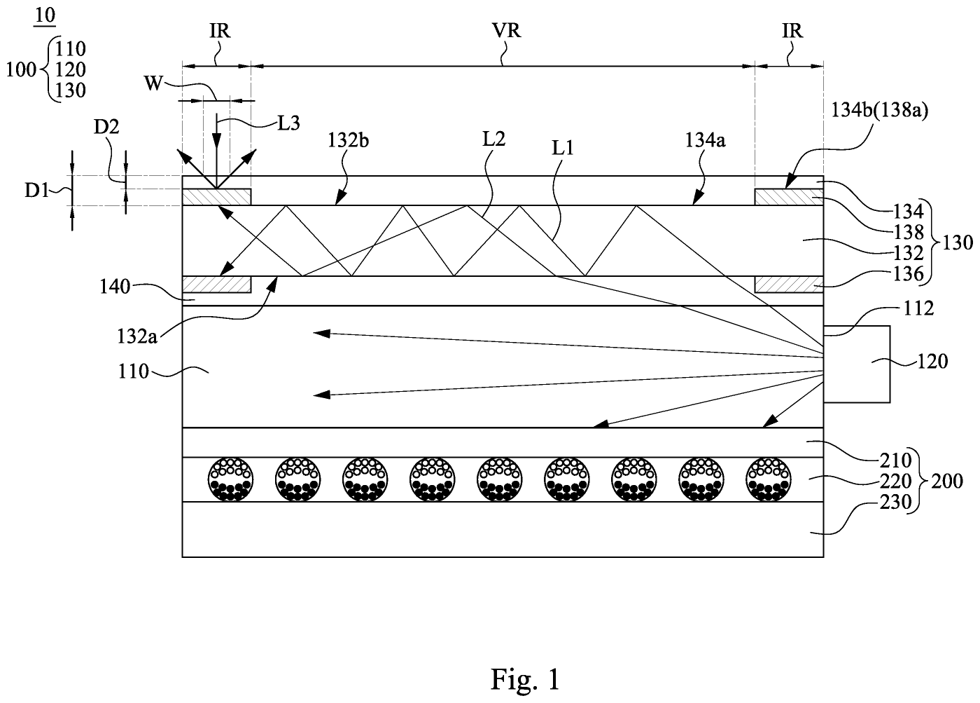

FIG. 1 is a cross-sectional view of a display device 10 according to one embodiment of the present disclosure. The display device 10 includes a front light module 100 and a display module 200. The front light module 100 includes a light guide plate 110, a light source 120, and a cover 130. The display module 200 includes a protection layer 210, a display medium layer 220, and a driving substrate 230. The light guide plate 110 has a light incident surface 112. The light source 120 faces the light incident surface 112. The cover 130 is located on the light guide plate 110. The cover 130 includes a first light guide layer 132, a second light guide layer 134, a first printing layer 136, and a second printing layer 138. The first light guide layer 132 is located between the second light guide layer 134 and the light guide plate 110. The second printing layer 138 is located between the first light guide layer 132 and the second light guide layer 134. The light guide plate 110 is located between the display module 200 and the cover 130. The display module 200 is a reflective display module, or other display module that can be utilized with a front light module, and the present disclosure is not limited in this regard.

As shown in FIG. 1, the display device 10 further includes an optical adhesive layer 140. The optical adhesive layer 140 is located between the light guide plate 110 and the first light guide layer 132. The first light guide layer 132 has a surface 132a facing the light guide plate 110 and a surface 132b facing the second light guide plate 134. The first printing layer 136 is located on the surface 132a of the first light guide layer 132, and the first printing layer 136 is in contact with the surface 132a. The second printing layer 138 is located on the surface 132b of the first light guide layer 132.

In the present embodiment, since the refractive index of the cover 130 is greater than the refractive index of the optical adhesive layer 140, the possibility of total internal reflection of the light in the cover 130 may be increased. Therefore, when the light is transmitted in the cover 130, a portion of the light may be transmitted to the edge of the cover 130. For example, as illustrated by the light L1 in FIG. 1, after the light L1 is emitted from the light source 120, the light L1 may be reflected in the first light guide layer 132 to the edge of the cover 130. With the configuration of the first printing layer 136, the light L1 can be absorbed by the first printing layer 136. Therefore, the light L1 is prevented from leaking through the edge of the cover 130. In addition, since the second printing layer 138 is located on the surface 132b of the first light guide layer 132, the light transmitting in the first light guide layer 132 may be absorbed. For example, as illustrated by the light L2 in FIG. 1, the light L2 is transmitted in the first light guide layer 132 and is reflected to the second printing layer 138. The second printing layer 138 may absorb the light L2. Therefore, the light L2 is prevented from leaking through the edge of the cover 130.

In the present embodiment, the second light guide layer 134 is a coating layer, and the coating layer is in contact with the first light guide layer 132 and the second printing layer 138. The second light guide layer 134 has a surface 134a in contact with the first light guide layer 132. The second light guide layer 134 has a surface 134b in contact with the second printing layer 138. In other words, there is a step between the surface 134a facing the first light guide layer 132 and the surface 134b.

In the present embodiment, a material of the first light guide layer 132 may include Polycarbonate (PC), Polymethyl Methacrylate (PMMA), glass, or combination thereof. A material of the second light guide layer 134 may include UV glue. In some embodiments, an anti-glare coating (AG coating) may be coated on the surface of the second light guide layer 134 facing away from the first light guide layer 132, or an anti-glare layer may be formed through imprinting the UV glue.

The display device 10 has a viewable region VR and a non-viewable region IR. The non-viewable region IR surrounds the viewable region VR. The non-viewable region IR is defined by the second printing layer 138. That is, an orthogonal projection of the second printing layer 138 on the first light guide layer 132 is overlapped with the non-viewable region IR. An orthogonal projection of the first printing layer 136 on the first light guide layer 132 may be overlapped with the non-viewable region IR. A distribution range of the first printing layer 136 is smaller than or equal to a distribution range of the second printing layer 138. That is, the entire first printing layer 136 is located in the non-viewable region IR.

In the present embodiment, the first printing layer 136 and the second printing layer 138 may be printed on the first light guide layer 132 first, and the material of the second light guide layer 134 may be coated on the first light guide layer 132. As shown in FIG. 1, since the second light guide layer 134 is formed through coating, the second light guide layer 134 located in the viewable region VR may has a thickness D1 in a range of 8 micrometers to 12 micrometers. The second light guide layer 134 located in the non-viewable region IR may has a thinner thickness D2. That is, the portion of the second light guide layer 134 overlapped with the second printing layer 138 may has a thickness D2 that is smaller than the thickness D1.

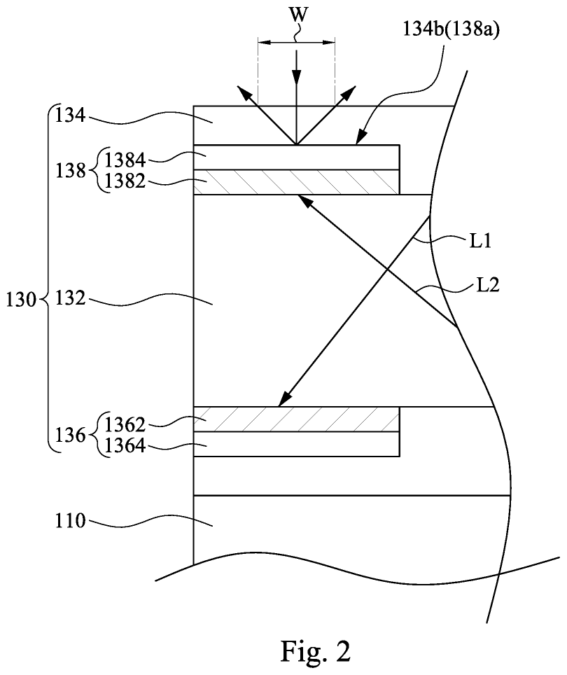

FIG. 2 is a partially enlarge view of the display device 10 in FIG. 1. In some embodiments, a number of the first printing layer 136 is plural. For example, the first printing layer 136 has a first sub-layer 1362 and a second sub-layer 1364. One of the first printing layer 136 closest to the first light guide layer 132 (i.e., the first sub-layer 1362) is a light absorbing layer. The first sub-layer 1362 is formed by printing black ink or deep color ink The light absorbing layer (i.e., the first sub-layer 1362) of the first printing layer 136 is in contact with the first light guide layer 132, and is configured to absorb the light L1. As such, the light L1 may be prevented from leaking through the edge of the cover 130. In some embodiments, a number of the second printing layer 138 is plural. For example, the second printing layer 138 has a first sub-layer 1382 and a second sub-layer 1384. One of the second printing layer 138 closest to the second light guide layer 138 (i.e., the first sub-layer 1382) is a light absorbing layer. The first sub-layer 1382 is formed by printing black ink or deep color ink. The light absorbing layer (i.e., the first sub-layer 1382) of the second light guide layer 138 is in contact with the first light guide layer 132, and is configured to absorb the light L2. As such, the light L2 may be prevented from leaking through the edge of the cover 130.

Number of layers of the first printing layer 136 and the second printing layer 138 may be different. The second sub-layer 1364 of the first printing layer 136 (or the other second sub-layers 1364 away from the first light guide layer 132) may be designed with various color. The second sub-layer 1384 of the second printing layer 138 (or the other second sub-layers 1384 away from the first light guide layer 132) may be designed with various color. For example, if the color of the housing of the display device 10 has red color, the second sub-layer 1364 of the first printing layer 136 and the second sub-layer 1384 of the second printing layer 138 may be designed with red color corresponding to the housing such that the appearance of the display device 10 may has uniform red color, but the present disclosure is not limited in this regard. In other words, it is required that the material or the color (e.g., deep color) of the first sub-layers 1362, 1382 that are closest to the first light guide layer 132 or are in contact with the first light guide layer 132 may be configured to absorb light.

As shown in FIG. 1 and FIG. 2, when the ambient light or the light transmitting in the cover 130 are transmitted to the surface 138a of the second printing layer 138 (that is the surface 134b of the second light guide layer 134), the light may be reflected. For example, light halo may be formed after the light L3 is reflected by the second printing layer 138. When the thickness D2 of the second light guide layer 134 is thinner, the width of the light halo is smaller. Accordingly, in the present embodiment, since the second light guide layer 134 is formed through coating, and the portion of the second light guide layer 134 overlapped with the second printing layer 138 has the thinner thickness D2, a range of the light halo can be reduced.

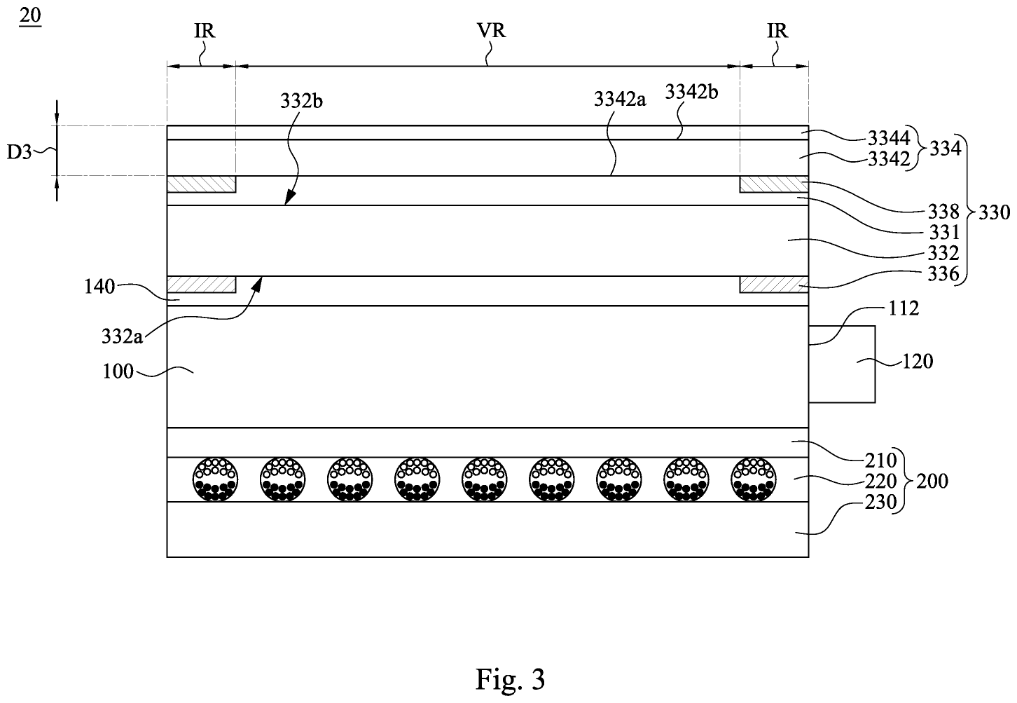

FIG. 3 is a cross-sectional view of a display device 20 according to another embodiment of the present disclosure. The display device 20 is substantially the same as the display device 10 shown in FIG. 1, the difference is that the configuration of the cover 330. The cover 330 of the display device 20 includes a first light guide layer 332, a second light guide layer 334, a first printing layer 336, a second printing layer 338, and an optical adhesive layer 331.

In the present embodiment, the optical adhesive layer 331 is located between the first light guide layer 332 and the second printing layer 338 and between the second light guide layer 334 and the first light guide layer 332. The second printing layer 338 is located on the surface 3342a of the second light guide layer 334 facing the first light guide layer 332. The second light guide layer 334 includes a sheet material and an anti-glare coating layer 3344. A material of the sheet material 3342 may include Polyethylene Terephthalate (PET) and/or Polycarbonate (PC).

In the present embodiment, the anti-glare coating layer 3344 may be coated on the surface 3342a of the second light guide layer 334, and the second printing layer 338 may be printed on the surface 3342b opposite to the surface 3342a. The second light guide layer 334 and the first light guide layer 332 are adhered through the optical adhesive layer 331. In the present embodiment, the entire surface 3342a of the second light guide layer 334 facing the first light guide layer 332 is planar, and the second light guide layer 334 has a thickness D3 in a range of 70 micrometers to 80 micrometers. The second printing layer 338 is in contact with the surface 3342a of the second light guide layer 334. The second printing layer 338 is spaced apart from the first light guide layer 332 by the optical adhesive layer 331. The optical adhesive layer 331 is in contact with the surface 332b of the first light guide layer 332, the surface 3342a of the second light guide layer 334, and the second printing layer 338. Since the second printing layer 338 is located on the surface 3342a of the second light guide layer 334, the portion of the optical adhesive layer 331 located between the second printing layer 338 and the first light guide layer 332 may has thinner thickness so as to fill the step due to the thickness difference formed by the second printing layer 338. The display device 20 and the display device 10 have substantially the same advantages, and the description is not repeated hereinafter.

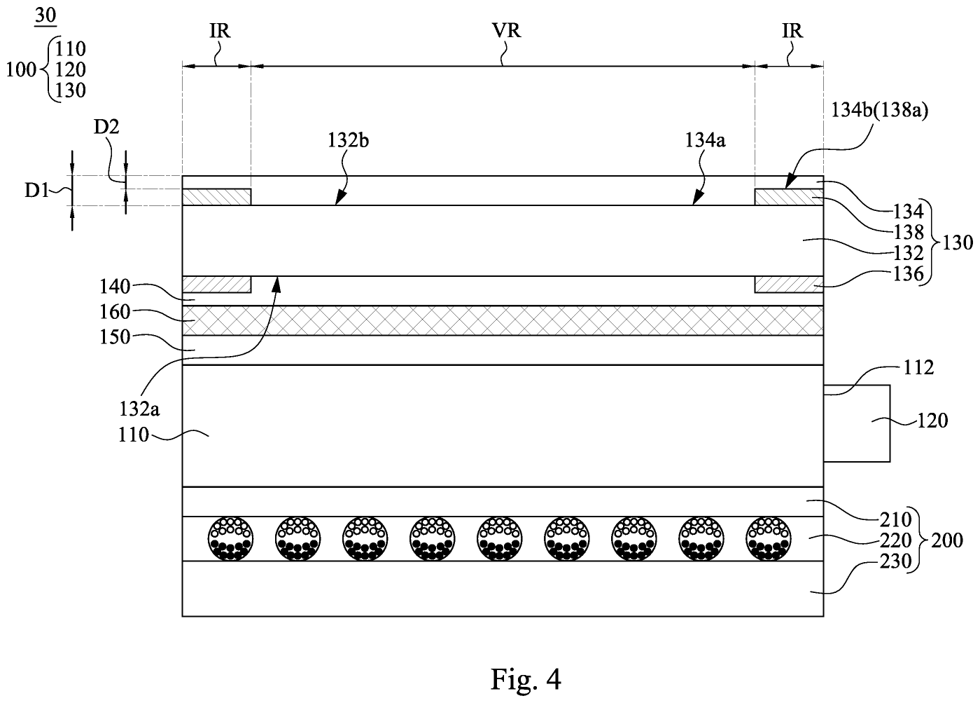

FIG. 4 is a cross-sectional view of a display device 30 according to another embodiment of the present disclosure. The display device 30 is substantially the same as the display device 10 shown in FIG. 1, and the difference is that the display device 30 further includes a touch layer 160 and another optical adhesive layer 150. The touch layer 160 is located between the light guide plate 110 and the cover 130, and the optical adhesive layer 150 is located between the light guide plate 110 and the touch layer 160. The display device 30 and the display device 10 shown in FIG. 1 have substantially the same advantages, and the description is not repeated hereinafter.

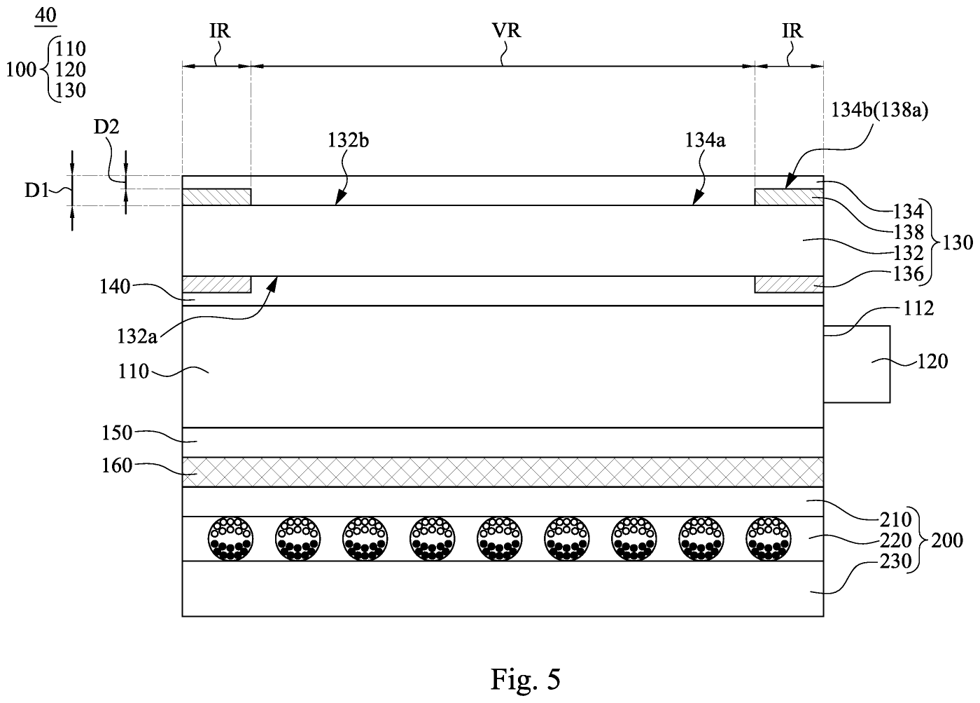

FIG. 5 is a cross-sectional view of a display device 40 according to another embodiment of the present disclosure. The display device 40 is substantially the same as the display device 30 shown in FIG. 4, and the difference is that a touch layer 160 of the display device 40 is located between the light guide plate 110 and the touch layer 160. The display device 40 and the display device 30 shown in FIG. 4 have substantially the same advantages, and the description is not repeated hereinafter.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A front light module, comprising:
a light guide plate having a light incident surface;
a light source facing the light incident surface of the light guide plate; and
a cover located on the light guide plate, wherein the cover comprises:
a first light guide layer;
a second light guide layer, wherein the first light guide layer is located between the second light guide layer and the light guide plate;
at least one first printing layer located on a surface of the first light guide layer facing the light guide plate; and
at least one second printing layer located between the first light guide layer and the second light guide layer.

2. The front light module of claim 1, wherein the first printing layer is in contact with the surface of the first light guide layer facing the light guide plate.

3. The front light module of claim 1, wherein a number of the first printing layer is plural, and one of the first printing layer closest to the first light guide layer is a light absorbing layer.

4. The front light module of claim 1, wherein the second printing layer is located on a surface of the first light guide layer facing the second light guide layer.

5. The front light module of claim 4, wherein the second light guide layer is a coating layer, and the coating layer is in contact with the first light guide layer and the second printing layer.

6. The front light module of claim 4, wherein the second light guide layer has a thickness in a range of 8 micrometers to 12 micrometers.

7. The front light module of claim 4, wherein a number of the second printing layer is plural, and one of the second printing layer closest to the first light guide layer is a light absorbing layer.

8. The front light module of claim 1, wherein the second printing layer is located on a surface of the second light guide layer facing the first light guide layer.

9. The front light module of claim 8, wherein the entire surface of the second light guide layer is planar, the second printing layer is in contact with the surface of the second light guide layer facing the first light guide layer, and the second printing layer is spaced apart from the first light guide layer.

10. The front light module of claim 8, wherein the second light guide layer has a thickness in a range of 70 micrometers to 80 micrometers.

11. A display device, comprising:
a front light module, comprising:
a light guide plate having a light incident surface;
a light source facing the light incident surface of the light guide plate; and
a cover located on the light guide plate, wherein the cover comprises:
a first light guide layer;
a second light guide layer, wherein the first light guide layer is located between the second light guide layer and the light guide plate;
at least one first printing layer located on a surface of the first light guide layer facing the light guide plate; and
at least one second printing layer located between the first light guide layer and the second light guide layer; and
a display module, wherein the light guide plate is located between the display module and the cover.

12. The display device of claim 11, wherein the first printing layer is in contact with the surface of the first light guide layer facing the light guide plate.

13. The display device of claim 11, wherein a number of the first printing layer is plural, and one of the first printing layer closest to the first light guide layer is a light absorbing layer.

14. The display device of claim 11, wherein the second printing layer is located on a surface of the first light guide layer facing the second light guide layer.

15. The display device of claim 14, wherein the second light guide layer is a coating layer, and the coating layer is in contact with the first light guide layer and the second printing layer.

16. The display device of claim 14, wherein the second light guide layer has a thickness in a range of 8 micrometers to 12 micrometers.

17. The display device of claim 14, wherein a number of the second printing layer is plural, and one of the second printing layer closest to the first light guide layer is a light absorbing layer.

18. The display device of claim 11, wherein the second printing layer is located on a surface of the second light guide layer facing the first light guide layer.

19. The display device of claim 18, wherein the entire surface of the second light guide layer is planar, the second printing layer is in contact with the surface of the second light guide layer facing the first light guide layer, and the second printing layer is spaced apart from the first light guide layer.

20. The display device of claim 18, wherein the second light guide layer has a thickness in a range of 70 micrometers to 80 micrometers.

21. The display device of claim 11, further comprising a touch layer, wherein the touch layer is located between the light guide plate and one of the cover and the display panel.
